(19) United States
(12) Patent Application Publication
(10) Pub. No.: US 2007/0141915 A1
(43) Pub. Date: Jun. 21, 2007

(54) CONNECTOR FOR PORTABLE MULTIMEDIA DEVICE

(75) Inventor: Myunggu KIM, Seoul (KR)

Correspondence Address: CANTOR COLBURN, LLP, 55 GRIFFIN ROAD SOUTH, BLOOMFIELD, CT, 06002, US

(73) Assignee: TAYLOR TECHNOLOGIES CO., LTD, Seoul (KR)

(21) Appl. No.: 11/558,211

(22) Filed: Nov. 9, 2006

(30) Foreign Application Priority Data
Nov. 9, 2005 (KR) 10-2005-0107215

(51) Int. Cl. H01R 31/00

(52) U.S. Cl. 439/640

(57) ABSTRACT

The present invention relates a connector for a portable multimedia device wherein an earphone for outputting a sound is integrated in a connector cable for transmitting a data, comprising a connector cable including a jack connector for coupling to a connection terminal of an audio device, the connector cable having a shape of a necklace; and a connector body connected to the connector cable, connector body housing a USB plug and an I/O plug, wherein the USB plug is detachable from the I/O plug. The connector of the portable multimedia device of the present invention may be used as the accessory such as the necklace, and may be used for a data exchange at a desired location. Therefore, in accordance with the connector of the portable multimedia device of the present invention, the earphone and the connector cable may be used independently.

### BACKGROUND OF THE INVENTION

1. Field of the Invention

The present invention relates to a connector for a portable multimedia device, and in particular to a connector for a portable multimedia device wherein an earphone for outputting a sound is integrated in a connector cable for transmitting a data.

2. Description of Prior Art

Recently, a performance of a portable device such as an MP3 player and a mobile phone is improving due to a progress in acoustic and communication technologies. Accordingly, a mobile communication provider provides extra services in addition to a unique communication service of the mobile phone. One of the extra services is a mobile Internet that provides various contents such as listening to music through the Internet, trading a stock on the Internet and an electronic commerce.

In order to take advantage of the various contents provided by the Internet or an information providing service, a connector shown in FIG. 1 is required.

As shown in FIG. 1, a connector 100 allows a data exchange by connecting a USB port 111 which is one of I/O ports of apparatus such as a PC 110, a laptop and a PDA to an I/O port 121 of an MP3 player 120. The connector 100 is also referred to as a PC linker and a data cable (standard 24 pin data cable).

The connector 100 allows a download of the various contents such as a music bell, an image and a game from the PC 110 through a date cable 103 or backup the data and the contents stored in the MP3 player 120 to the PC 110.

As shown in FIG. 1, a USB port 101 and an I/O terminal 102 connected to the I/O port 121 of the MP3 player 120 is connected by the data cable 103 having a length of 1 meter. The data cable 103 is sold as shown in FIG. 1, and a portable bag for carrying the connector 100 is required due to the length of the data cable 103.

Moreover, a separate earphone 130 is required to listen to a downloaded audio file and the earphone 130 should always be carried by a user. Therefore, a loss or damage of the earphone may occur.

That is, the connector cable and the earphone are two separate independent products and used in a separated state. Therefore, carrying both of the connector cable and the earphone is very inconvenient.

Accordingly, carrying the connector is almost impossible, and should be carried only when required or should be kept in a predetermined place.

In addition, due to a drastic increase in the number of the portable multimedia device and a diversification of the contents for the portable multimedia device, types and amounts of a data to be stored in the portable multimedia device are rapidly increasing. Therefore, the data stored in the MP3 player 120 or the mobile phone is required to be backed up at anytime and various data and contents provided from an external device are required to be downloaded or stored at any time regardless of a place.

Examples of the above-described technology are disclosed in Korean Patent Publication No. 2003-37429 and Korean Patent Publication No. 2005-27395.

However, in accordance with the technology described in the publications, the connector 100 cannot be easily carried. Therefore the user is allowed to transfer the data in a place where the connector 100 is stored or equipped.

That is, while the MP3 player 120 and the earphone 130 may be carried at all times, the connector 100 is not manufactured to be carried at all times or is not modified to a portable form. Therefore, a characteristic and an advantage of the MP3 player 120 and the mobile phone wherein a communication (a wireless communication and a data communication using the connector 100) is established freely anywhere are limited.

Moreover, when the earphone 130 and the connector 100 are separately carried to be used, the earphone 130 and the connector 100 may be lost.

### SUMMARY OF THE INVENTION

It is an object of the present invention to provide a connector for a portable multimedia device wherein a connector cable for transmitting a data and an earphone for outputting a sound are integrated as one so as to provide a convenience and to be easily used.

It is another object of the present invention to provide a connector for a portable multimedia device that prevents losing of an earphone or a connector.

It is yet an object of the present invention to provide a connector for a portable multimedia device that prevents a mis-insertion of a connector into connectors of a portable multimedia device and a peripheral device such as a computer.

In order to achieve the above-described objects of the present invention, there is provided a connector of a portable multimedia device, the connector comprising: a connector cable including a jack connector for coupling to a connection terminal of an audio device, the connector cable having a shape of a necklace; and a connector body connected to the connector cable, connector body housing a USB plug and an I/O plug, wherein the USB plug is detachable from the I/O plug.

The connector body is disengaged as a first body and a second body, wherein the first body houses the I/O plug connected to the portable multimedia device and the second body houses the USB plug connected to a data processing apparatus.

The first body includes a USB plug housing unit for housing the USB plug, and the second body includes an I/O plug housing unit for housing the I/O plug, wherein the first body plugging into the second body to be engaged.

The connector in accordance with the present invention further comprises an earphone line detachable from the connector cable, an earphone disposed at an end of the detachable earphone line, and a coupling means for attaching and detaching the earphone line and the connector cable.

The connector cable includes an internal earphone line for electrically connecting the jack connector to the earphone.

The coupling means includes a through-hole for inserting the connector cable, and a hook for an attachment and a detachment of the earphone disposed at one side of the through-hole.

The portable multimedia device is one of a MP3 player, a portable gaming apparatus, a portable broadcast receiver, a mobile phone, a PMP, a digital camera and portable communication device.

### BRIEF DESCRIPTION OF THE DRAWINGS

FIG. 1 is a diagram illustrating a conventional USB cable for connecting a computer and a portable multimedia device using a USB port.

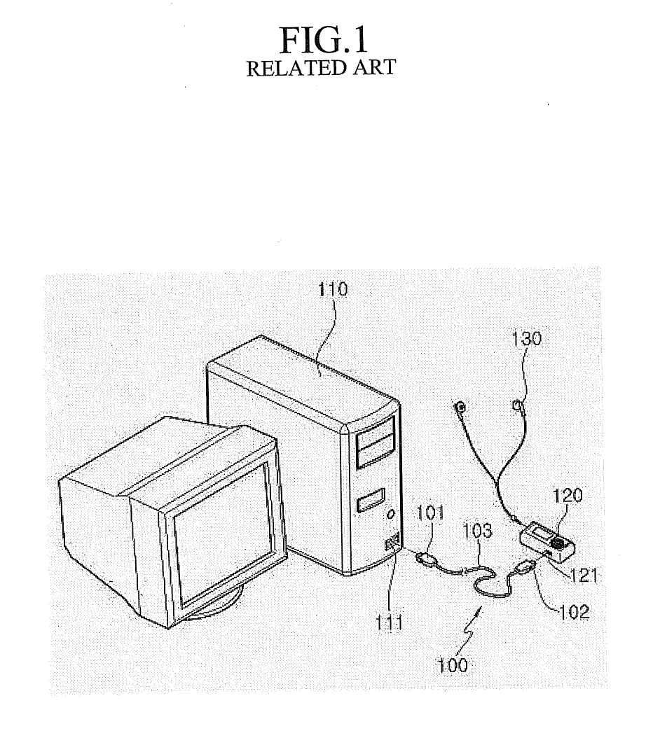

FIG. 2 is a perspective view illustrating a connector of a portable multimedia device in accordance with an embodiment of the present invention.

FIG. 3 is a perspective view illustrating a coupling structure of a body of a connector of a portable multimedia device in accordance with an embodiment of the present invention.

FIG. 4 is a diagram illustrating a connector of a portable multimedia device for connecting a computer and the portable multimedia device using a USB port.

FIG. 5 is a diagram illustrating an operation status of a connector of a portable multimedia device in accordance with of the present invention.

FIG. 6 is a perspective view illustrating a first body and a second body in accordance with of the present invention.

### [DESCRIPTION OF REFERENCE NUMERALS]

1: jack connector 10: connector cable
11: connector body 12: a first body
13: a second body 16: rib
20: earphone line 30: earphone
40: coupling means

### DETAILED DESCRIPTION OF THE PREFERRED EMBODIMENTS

The present invention will now be described in detail with reference to the accompanied drawings.

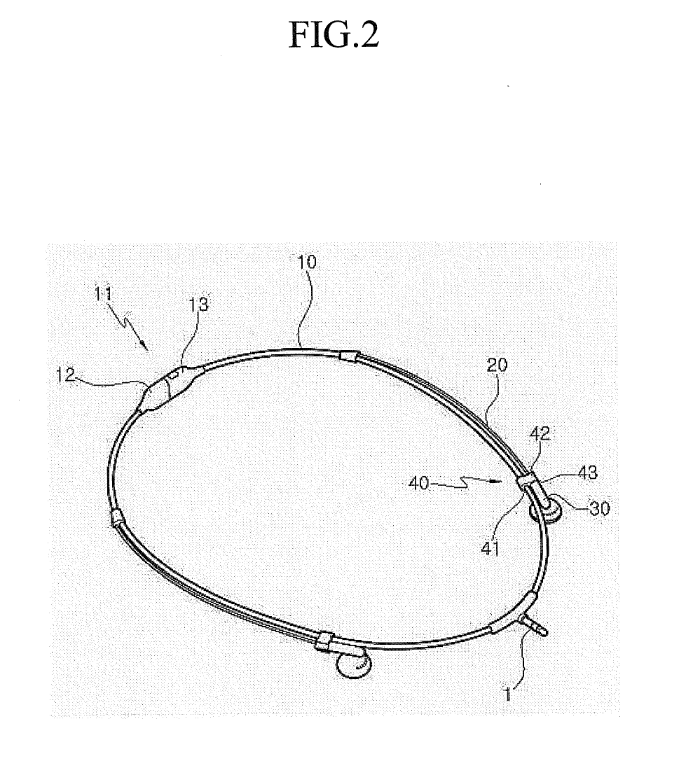

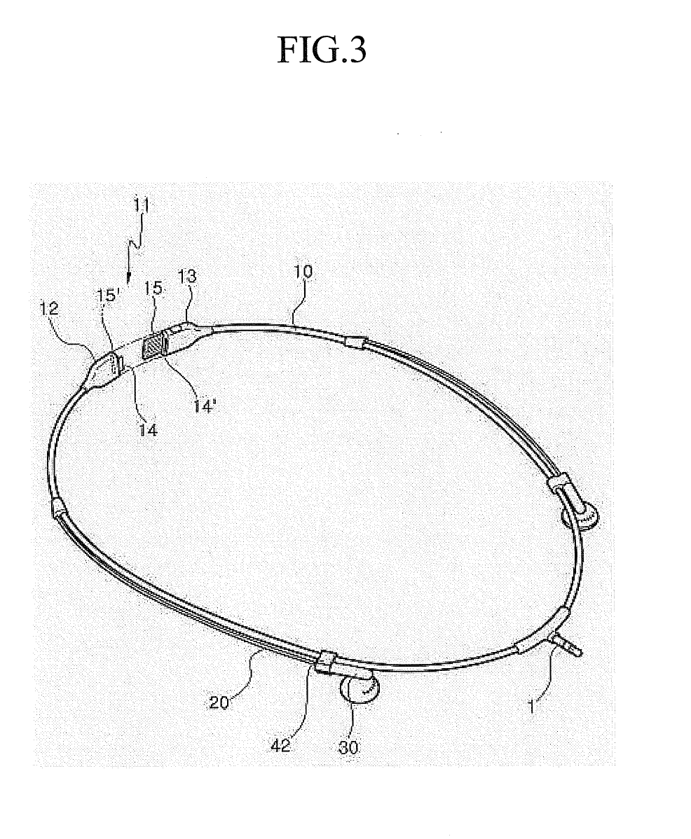

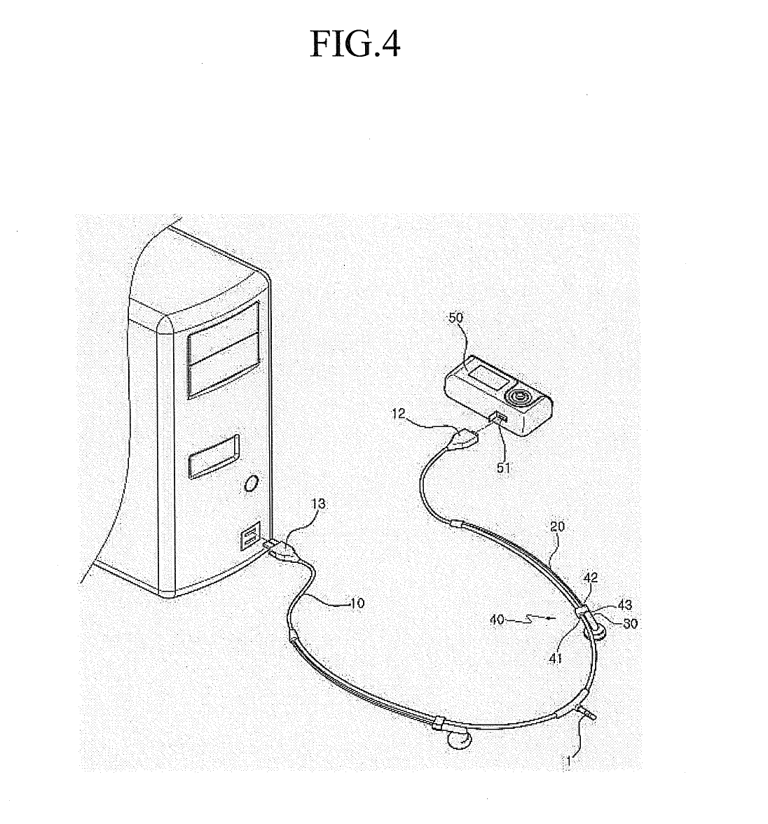

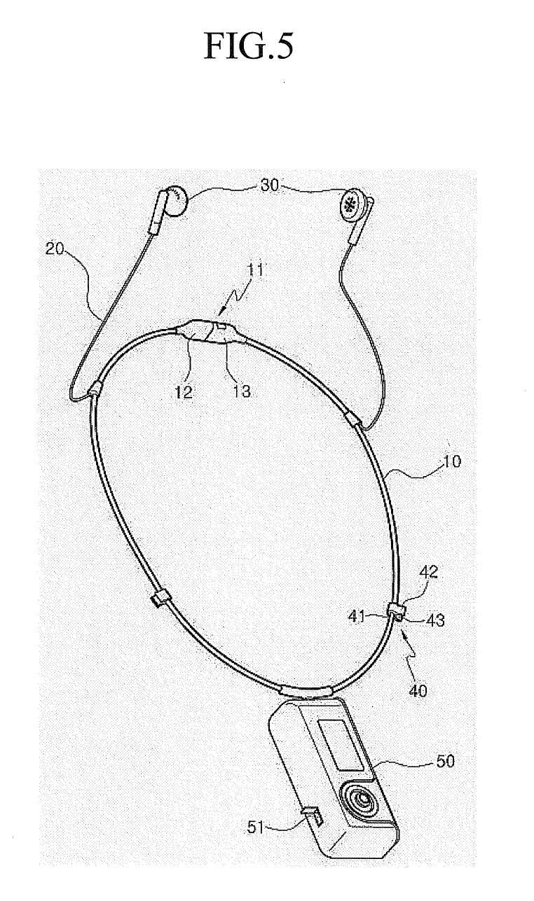

FIG. 2 is a perspective view illustrating a connector of a portable multimedia device in accordance with an embodiment of the present invention, FIG. 3 is a perspective view illustrating a coupling structure of a body of a connector of a portable multimedia device in accordance with an embodiment of the present invention, FIG. 4 is a diagram illustrating a connector of a portable multimedia device for connecting a computer and the portable multimedia device using a USB port, and FIG. 5 is a diagram illustrating an operation status of a connector of a portable multimedia device in accordance with of the present invention.

As shown in FIGS. 2 and 3, a connector of a portable multimedia device in accordance with an embodiment of the present invention comprises a connector cable 10 including a jack connector 1 for coupling to a connection terminal of an audio device of the portable multimedia device, a connector body 11 housing a USB and an I/O plug, an earphone line 20 detachable from the connector cable 10, an earphone 30 disposed at an end of the detachable earphone line 20, and a coupling means 40 for attaching and detaching the earphone line 20 at a side of the connector cable 10.

The connector cable 10 has a circular shape similar to a necklace to be worn around a neck, and comprises the jack connector 1 for connecting to the connection terminal of the audio device of the portable multimedia device. It is preferable that the jack connector 1 is disposed at a center of the connector cable 10 in a lengthwise direction of the connector cable 10. That is, the connector cable 10 has a shape that may serve as an accessory to be worn around the neck.

In addition, a plurality of cables (not shown) for a transmission and a reception of a data are housed in the connector cable 10. Moreover, the connector cable 10 further comprises the earphone line 20 for electrically connecting the jack connector 1 and the earphone 30.

In addition, the earphone line 20 for electrically connecting the jack connector 1 and the earphone 30 is integrated in the connector cable 10 for a predetermined length in the connector cable 10 and then is separated from the connector cable 10. The separated earphone line 20 extends to a predetermined length and an end portion thereof is connected to the earphone 30.

The coupling means 40 for attaching and detaching the earphone line 20 is coupled to the connector cable 10. The coupling means 40 includes a through-hole 41 for inserting the connector cable 10 at one side, and a hook 42 for an attachment and a detachment of the earphone 30 disposed at the other side of the through-hole 41. It is preferable that the hook 42 is elastic and has a circular shape, and includes an insertion groove 43 for inserting the earphone 30.

As shown in FIG. 3, the connector body 11 is disengaged as a first body 122 and a second body 13 consisting of a plastic, a rubber or a resin, and the first body 12 plugs into the second body 13 to be engaged.

An I/O plug 14 for connecting to an I/O port of the portable multimedia device such as an MP3 player is disposed in the first body 12. In addition, a USB plug housing unit 15′ for housing a USB plug described below is disposed in the first body 12 to protect the USB plug.

A USB plug 15 for connecting to a USB port of a computer is disposed in the second body 13. In addition, an I/O plug housing unit 14′ for housing the I/O plug 14 is disposed in the second body 13 to protect a connector of the I/O plug 14.

In accordance with the connector of the portable multimedia device according to the embodiment of the present invention, the first body 12 and the second body 13 are disengaged from the connector body 11, and the I/O plug 14 of the first body 12 is plugged into an I/O connector 51 of the portable multimedia device when the data is transmitted to and received from the computer by the portable multimedia device such as an MP3 player 50 as shown in FIG. 4. Thereafter, the USB plug 15 of the second body 13 is plugged into an I/O terminal of the computer to receive and transmit a desired data.

When not transmitting and receiving data, the first body 12 and the second body 13 are engaged so as to be used as the accessory that is wearable around the neck.

As shown in FIG. 5, when a user desired to listen to a music while wearing the connector cable 10 around the neck, the earphone 30 is disengaged from the hook 42 of the coupling means 40 coupled to the one side of the connector cable 10 and the jack connector 1 is then inserted into the connection terminal of the portable multimedia device to listen to the music from the portable multimedia device.

The connector cable of the portable multimedia device provides the transmission and the reception of the data by connecting to an information apparatus such as the computer, may be used as the accessory wearable around the neck by an engagement structure of a connector body and includes the earphone so that the user may listen to the music.

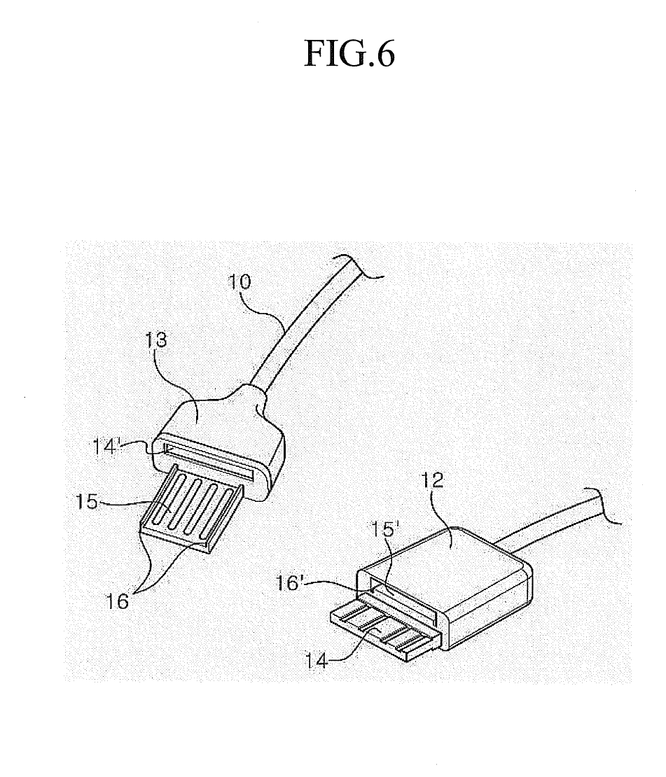

Constitutions of the first body 12 and the second body 13 will now be described in detail with reference to FIG. 6.

FIG. 6 is a perspective view illustrating a first body and a second body in accordance with of the present invention.

As shown in FIG. 6, a rib 16 is disposed at each side of the USB plug 15 in the second body 13 to guide an insertion into a USB port of a peripheral device such as a data processing apparatus by sliding the USB plug 15 and to prevent a mis-insertion of the USB plug 15 during a plugging of to the USB port of the peripheral device such as the data processing apparatus.

A rib inserting hole 16′ having a groove corresponding to the rib 16 is disposed in the USB plug housing unit 15′.

As shown in FIG. 6, a damage of the portable multimedia device due to the mis- insertion of the plug may be prevented by disposing the rib 16.

While the present invention has been particularly shown and described with reference to the preferred embodiment thereof, it will be understood by those skilled in the art that various changes in form and details may be effected therein without departing from the spirit and scope of the invention as defined by the appended claims.

That is, while the embodiment of the present invention is described by exemplifying a use of the connector of the portable multimedia device for the MP3 player, the present invention may be applied to a portable gaming apparatus, a portable broadcast receiver, a mobile phone, a PMP, a digital camera and portable communication device.

As described above, the connector of the portable multimedia device of the present invention may be used as the accessory such as the necklace, and may be used for a data exchange at a desired location. Therefore, in accordance with the connector of the portable multimedia device of the present invention, the earphone and the connector cable may be used independently.

Moreover, the connector of the portable multimedia device of the present invention comprises the rib for preventing the mis-insertion during the plugging of the USB port of the data processing apparatus so that the damage of the portable multimedia device due to the mis-insertion of the plug may be prevented.

1. A connector of a portable multimedia device, the connector comprising:
a connector cable including a jack connector for coupling to a connection terminal of an audio device, the connector cable having a shape of a necklace; and
a connector body connected to the connector cable, connector body housing a USB plug and an I/O plug,
wherein the USB plug is detachable from the I/O plug.

2. The connector in accordance with claim 1, wherein the connector body is disengaged as a first body and a second body, the first body housing the I/O plug connected to the portable multimedia device and the second body housing the USB plug connected to a data processing apparatus.

3. The connector in accordance with claim 2, wherein the first body includes a USB plug housing unit for housing the USB plug, and the second body includes an I/O plug housing unit for housing the I/O plug, the first body plugging into the second body to be engaged.

4. The connector in accordance with claim 3, further comprising an earphone line detachable from the connector cable, an earphone disposed at an end of the detachable earphone line, and a coupling means for attaching and detaching the earphone line and the connector cable.

5. The connector in accordance with claim 4, wherein the connector cable includes an internal earphone line for electrically connecting the jack connector to the earphone.

6. The connector in accordance with claim 4, wherein the coupling means includes a through-hole for inserting the connector cable, and a hook for an attachment and a detachment of the earphone disposed at one side of the through-hole.

7. The connector in accordance with claim 1, wherein the portable multimedia device is one of a MP3 player, a portable gaming apparatus, a portable broadcast receiver, a mobile phone, a PMP, a digital camera and portable communication device.

8. The connector in accordance with claim 3, wherein a rib is disposed at both side surfaces of the USB plug.

9. The connector in accordance with claim 8, wherein the USB plug housing unit includes a rib inserting hole for housing the rib.

10. The connector in accordance with claim 2, wherein the portable multimedia device is one of a MP3 player, a portable gaming apparatus, a portable broadcast receiver, a mobile phone, a PMP, a digital camera and portable communication device.

11. The connector in accordance with claim 3, wherein the portable multimedia device is one of a MP3 player, a portable gaming apparatus, a portable broadcast receiver, a mobile phone, a PMP, a digital camera and portable communication device.

12. The connector in accordance with claim 4, wherein the portable multimedia device is one of a MP3 player, a portable gaming apparatus, a portable broadcast receiver, a mobile phone, a PMP, a digital camera and portable communication device.

13. The connector in accordance with claim 5, wherein the portable multimedia device is one of a MP3 player, a portable gaming apparatus, a portable broadcast receiver, a mobile phone, a PMP, a digital camera and portable communication device.

14. The connector in accordance with claim 6, wherein the portable multimedia device is one of a MP3 player, a portable gaming apparatus, a portable broadcast receiver, a mobile phone, a PMP, a digital camera and portable communication device.
